(19) United States
(12) Patent Application Publication
(10) Pub. No.: US 2009/0119333 A1
(43) Pub. Date: May 7, 2009

(54) Methods, Systems, And Computer Readable Media For Associating Information With A Digital Image

(76) Inventors: Robert J. Sundstrom, Cary, NC (US); David B. Lection, Raleigh, NC (US)

Correspondence Address: SCENERA RESEARCH, LLC, 111 CORNING RD., SUITE 220, CARY, NC, 27518, US

(21) Appl. No.: 11/934,223

(22) Filed: Nov. 2, 2007

(51) Int. Cl. G06F 17/30

(52) U.S. Cl. 707/104.1; 707/E17.019

(57) ABSTRACT

The subject matter described herein includes methods, systems, and computer readable media for associating information with a digital image. According to one method, a digital image having associated metadata that corresponds to a first entity in a dataset that includes hierarchical relationships between entities is received. A subject perspective is identified for the digital image for a subject corresponding to a second entity in the dataset. Information for the digital images retrieved from the dataset based on a hierarchical relationship between the first and second entities in the dataset. The retrieved information is associated with the digital image.

### BACKGROUND

Digital images, such as digital photographs captured by a digital camera, scanned images, images from video frames, or images produced with the aid of a computer, often contain or are associated with data that is descriptive of the image content or other aspect of the digital image. Data that is descriptive of the content or other aspect of the digital image is referred to as metadata. One type of metadata that is currently associated with digital photos is time and date metadata. Time and date metadata may be created by a digital camera when a photograph is created and stored with the digital image file. Another type of metadata that can be associated with a digital image is a caption. For example, digital photo organization programs allow a user to manually create a caption for a digital photo. The caption may be stored with the digital photo as metadata.

It may be desirable to associate additional information with a digital image, for example, to enhance information communicated by the digital image. One type of information that it may be desirable to associate with a digital image is relationship information. One type of relationship information that may be associated with a digital image is the relationship between subjects depicted in the digital image or relationships between subjects depicted in the digital image and a viewer of the digital image. Relationships between people can be important in presenting photo albums to a viewer. For example, a viewer may wish to know the identity of a person in a photo and that person's relationship to others in the photo. It may also be desirable to know the ages of people depicted in a photo. Other types of information that it may be desirable to associate with a digital image include location and event information.

Using existing photo organization software, manual creation of captions by a user is required to enrich image metadata content. One problem with such manual editing is that it is time and labor intensive. Another problem associated with the use of manual editing to create enhanced metadata for a photo is that such manual editing does not allow metadata associated or presented with a photo to be customized differently for different viewers. For example, if the subject of a photo is Tom and his Grandfather, William, Tom may wish for the caption to read, “Tom with Grandfather William.” However, for the same photo, Tom's Grandfather may wish the photo caption to read, “Grandfather William with Grandson Tom.” Requiring manual editing to create the different captions or other metadata for the different recipients is undesirable due to the amount of time and labor that would be involved.

Accordingly, there exists a need for methods, systems, and computer readable media for associating information with a digital image.

### SUMMARY

The subject matter described herein includes methods, systems, and computer readable media for associating information with a digital image. According to one method, a digital image having associated metadata that corresponds to a first entity in a dataset that includes hierarchical relationships between entities is received. A subject perspective is identified for the digital image for a subject corresponding to a second entity in the dataset. Information for the digital images is retrieved from the dataset based on a hierarchical relationship between the first and second entities in the dataset. The retrieved information is associated with the digital image.

According to another aspect, a system for associating information with a digital image is provided. The system includes an image data selector component for receiving a digital image having associated metadata that corresponds to a first entity in a dataset that includes hierarchical relationships between entities. The system further includes a perspective identifier component for identifying a subject perspective for the digital image for a subject corresponding to a second entity in the dataset. The system further includes a subject perspective component for retrieving information for the digital image from the dataset based on the hierarchical relationship between the first and second entities in the dataset. The system further includes an image information component for associating the retrieved information with the digital image.

According to another aspect, a computer readable medium containing a computer program executable by a machine for associating information with a digital image is provided. The computer program includes executable instructions for receiving a digital image having associated metadata that corresponds to a first entity in a dataset that includes hierarchical relationships between entities. The computer program further includes instructions for identifying a subject perspective for the digital image for a subject corresponding to a second entity in the dataset. The computer program further includes instructions for retrieving information for the digital image from the dataset based on a hierarchical relationship between the first and second entities in the dataset. The computer program further includes instructions for associating the retrieved information with the digital image.

According to another aspect, a system for associating information with a digital image is provided. The system includes means for receiving a digital image having associated metadata that corresponds to a first entity in a dataset that includes hierarchical relationships between entities. The system further includes means for identifying a subject perspective for the digital image for a subject corresponding to a second entity in the dataset. The system further includes means for retrieving information for the digital image from the dataset based on a hierarchical relationship between the first and second entities in the dataset. The system further includes means for associating the retrieved information with the digital image.

### BRIEF DESCRIPTION OF THE DRAWINGS

Preferred embodiments of the subject matter described herein will now be explained with reference to the accompanying drawings of which:

FIG. 1 is a flow chart illustrating an exemplary process for associating information with a digital image according to an embodiment of the subject matter described herein;

FIG. 2A is a block diagram illustrating exemplary components arranged for associating information with a digital image according to an embodiment of the subject matter described herein;

FIG. 2B is a block diagram illustrating components of an exemplary hierarchical dataset according to an embodiment of the subject matter described herein;

FIG. 3 is a block diagram illustrating an exemplary graphical user interface for providing for selection of a subject perspective according to an embodiment of the subject matter described herein;

FIG. 4 is a block diagram illustrating exemplary relationships between entities in a hierarchical dataset according to an embodiment of the subject matter described herein;

FIG. 5 is a diagram illustrating a drawing of a digital image and associated metadata;

FIG. 6 is a diagram of the digital image illustrated in FIG. 5 where additional information has been retrieved from a hierarchical dataset and displayed with the digital image according to an embodiment of the subject matter described; and

FIGS. 7A and 7B illustrate exemplary metadata corresponding to a subject perspective that may be associated with a digital image according to an embodiment of the subject matter described herein.

### DETAILED DESCRIPTION

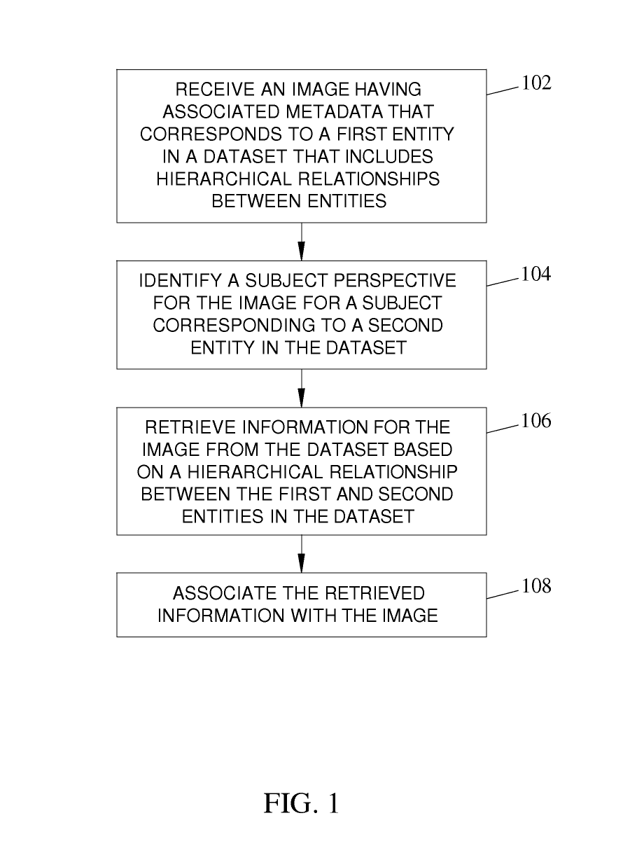

According to one aspect of the subject matter described herein, a method for associating information with a digital image is provided. FIG. 1 is a flow chart of an exemplary method for associating information with a digital image according to an embodiment of the subject matter described herein. Referring to FIG. 1, in block 102, a digital image having associated metadata that corresponds to a first entity in a dataset that includes hierarchical relationships between entities is received. For example, the digital image may have associated metadata that identifies a person, a location, an event, or other aspect of the digital image, where the metadata corresponds to a first entity in a dataset.

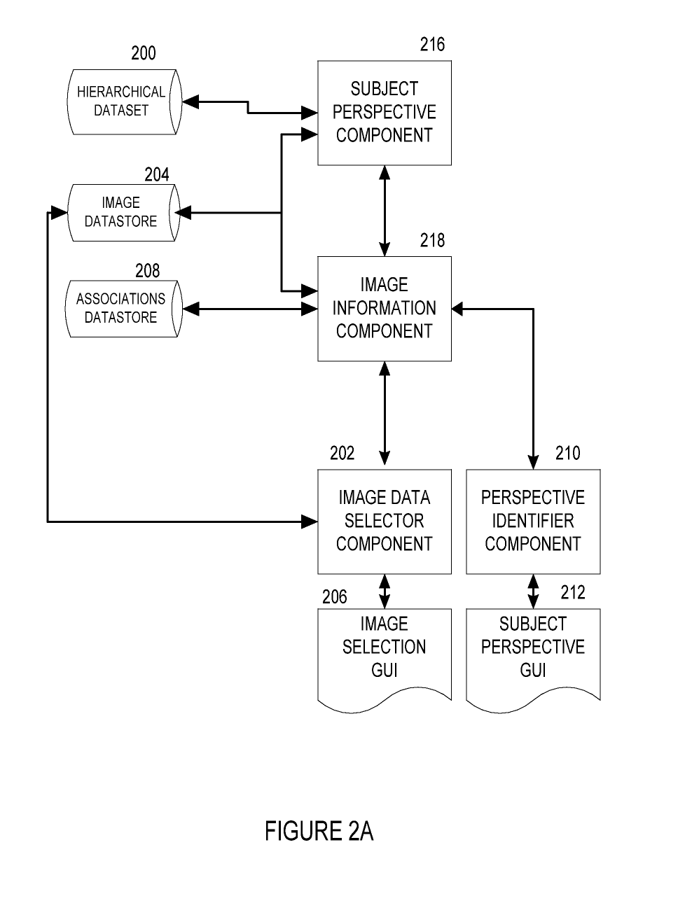

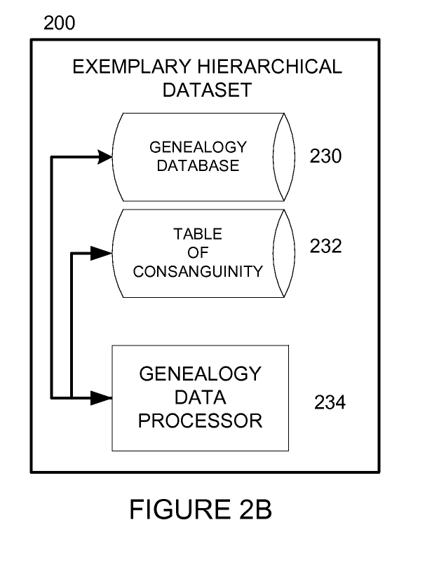

FIG. 2A is a block diagram illustrating components that can be used for associating information with a digital image according to an embodiment of the subject matter described herein. With reference to FIG. 2A, the hierarchical dataset 200 includes hierarchical relationships between entities of the hierarchical dataset 200. For example, if the metadata identifies a person, the metadata may correspond to a record in hierarchical dataset 200 for that person. In one example, hierarchical dataset 200 may include a genealogy database with hierarchical relationships between people. One example of a genealogy database suitable for use with the subject matter described herein is the Genealogical Data Communication or GEDCOM database developed by the Church of Jesus Christ of Latter Day Saints.

FIG. 2A includes means for receiving a digital image having associated metadata that corresponds to the first entity in the hierarchical dataset 200. For example, an image data selector component 202 may receive a digital image and metadata associated with the digital image from an image datastore 204. For example, image data selector component 202 may receive the digital image from a computer, a camera, a mobile phone, a smart phone, a scanner, or any other device that produces, stores, or communicates digital images. In an exemplary embodiment, image data selector component 202 can receive the digital image via user selection of a digital image. For example, image data selector component 202 can receive the digital image via an image selection graphical user interface (GUI) 206 that is operatively connected to or included as part of image data selector component 202. Image selection GUI 206 provides for user selection of digital image files. In any event, the digital image files can be received from image datastore 204 using any of various methods, which may also include employing a computer's file system or the use of one or more program calls to an image application via, for example, an application programming interface (API).

Once a digital image has been received by image data selector component 202, the digital image may be stored for viewing and processing in a data store, which may be any data store accessible to image data selector component 202, including but not limited to image datastore 204. The metadata that was originally associated with the digital image may be received with the digital image or separately. For example, the metadata may be stored in the EXIF header or other data storage area of the digital image based on the digital image's file specification. In an alternate implementation, the metadata may be stored with the digital image in the same record in image datastore 204. In yet another alternate implementation, the digital image may be stored in a separate record of image datastore 204 and may be associated with the record with which the digital image is stored or indexed. In yet another alternate implementation, the digital image metadata may be stored in a separate metadata database and associated with the corresponding record in image datastore 204.

Returning to FIG. 1, in block 104, a subject perspective for a subject corresponding to a second entity in hierarchical dataset 200 is identified. As used herein, the term “subject perspective” refers to a context from which information will be retrieved about a digital image for association with the digital image. For example, if the context is such that the information should relate to a relationship between a viewer of the digital image and the first entity that is a person in the digital image, then the subject perspective is the viewer's perspective. The subject perspective can also be the perspective of one entity in the digital image to another in which case the information would relate to a relationship between the two entities in the digital image. Many other examples of subject perspectives exist.

More particularly, in continuing with the example above, the original metadata associated with a digital image may identify one person in the digital image, and the subject perspective may be identified to be a context corresponding to a second person in the digital image where the second person has a corresponding record in hierarchical dataset 200. Thus, in this example, the second entity in the dataset may be a record in hierarchical dataset 200 for the second person. The first and second entities may be on the same or different hierarchical levels in the hierarchical dataset 200. For example, in the case of first and second people in a genealogy database, the entities may be parent and child, which are on different levels, or may be siblings, which are on the same level. Whether the first and second entities are on the same or different hierarchical levels in the hierarchical dataset 200, the entities will have a hierarchical relationship on which the information retrieved is based, as is discussed in more detail below.

The subject matter described herein is not limited to identifying subject perspectives based on human subjects depicted in a photo. Additional examples of subject perspectives that may be identified include location perspectives, viewer perspectives, and event perspectives.

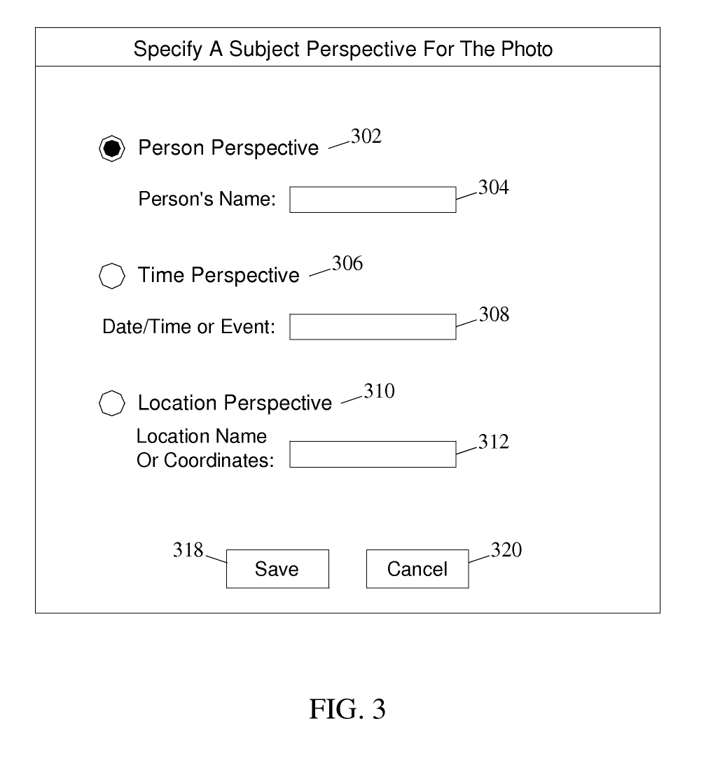

The subject matter described herein may include means for identifying a subject perspective for a subject corresponding to a second entity in the dataset. Referring to FIG. 2A, in an embodiment, perspective identifier component 210 may include and/or communicate with a subject perspective GUI 212 to capture user input for selecting a subject perspective for the digital image. FIG. 3 is a block diagram illustrating an exemplary screen that may be presented via subject perspective GUI 212. Referring to FIG. 3, subject perspective GUI 212 allows selection of a plurality of types of subject perspectives, including a person perspective, a time/date or event perspective, and a location perspective. In the illustrated example, if person perspective radio button 302 is selected, the subject perspective is identified from the point of view of a human. The person's name is entered in a text entry field 304. In an alternate embodiment, a person can be selected by displaying the hierarchy of a family tree or list of individuals represented in hierarchical dataset 200 that is a genealogy database and allowing selection of a subject from the hierarchy. Text entry field 304 can be preloaded with the current user of the application, for example, derived from the user's login credentials.

Radio button 306 allows a user to select a time perspective. Text box 308 allows the user to specify a data and time or an event. If time perspective radio button 306 is selected as the subject perspective, the subject perspective is identified from the point in time. Time may be entered in any suitable manner. In the illustrated example, time can be entered as text in text entry field 308. In an alternate embodiment, calendar and clock GUIs may be displayed to allow the user to specify a date and time using the calendar GUI to select the date and the clock GUI to select the time.

In addition, if an event perspective is desired, the event name can be entered. If an event name is entered, hierarchical dataset 200 illustrated in FIG. 2A may be searched for a record of the event. If a record of the event is found, the date and time is added to the subject perspective. Having an event name as well as a date and time allows for finer grain searching for a subject perspective related to the event or time/date of the event. In an alternate embodiment, an event may be selected by displaying a list of events from events represented in hierarchical dataset 200 and allowing selection of an event from the list of events. The time and date can also be determined by performing analysis of the metadata associated with the digital image and presenting the user with a list of choices for the time and date is based on the content in the metadata. The time and date can also be used to help select the event. For example, Jul. 4, 1940 may be a birthday and a wedding anniversary as well as a national holiday. The user can be presented with a selection of candidate events, based on the date/time metadata in digital image file and matching that with events in the dataset. Or the date/time can be entered and then the candidate events presented.

Radio button 310 allows the user to select a location perspective as the subject perspective. If location perspective radio button 310 is selected, the user may enter a location perspective in text entry field 312. The location may be entered in any suitable manner. For example, the user may enter text indicative of the location, such as “New York City,” or the user may enter a set of GPS coordinates. If GPS coordinates are entered, the GPS coordinates can be converted to a textual description of a location using a database that converts GPS coordinates into location descriptions. In an alternate implementation, selection of radio button 310 may cause a map to be displayed or a drop down menu to be displayed where the user selects a location from the map or the drop down menu. The location may also be determined by analysis of metadata associated with the digital image and presenting the user with a list of choices for location based on the digital image content and the associated metadata.

In one exemplary implementation, radio buttons 302, 306, and 310 may form a radio button group. Such a radio button group may allow a single mutually exclusive selection. So when component 302 is selected, the other radio buttons in the group may be deselected. In alternate implementation, a user can be allowed to select multiple radio buttons or use other GUI devices to select multiple subject perspectives for a digital image.

Once the user selects a subject perspective for the digital image, the user may select a save button 318 to save the perspective or a cancel button 320 to cancel the selection of the perspective. Once save button 318 or cancel button 320 is selected, subject perspective GUI 212 is removed from the display. The subject perspective may be saved in a memory for later use.

Returning to FIG. 1, in block 106, information for the digital image is retrieved from the dataset based on a hierarchical relationship between the first and second entities in the dataset. Continuing with the example above, if the digital image metadata corresponds to a record for a first person depicted in the digital image and the subject perspective is selected to be for a second person corresponding to a second record in hierarchical dataset 200, the information extracted from hierarchical dataset 200 may be a relationship between the first and second people from the point of view of the second person. In an example, hierarchical dataset 200 is a genealogy database and the second person is a direct offspring of the first person. Accordingly, the information retrieved from hierarchical dataset 200 may indicate “second person with (mother or father).” In another example, hierarchical dataset 200 is a genealogy database and the second person is a sibling of the first person. Accordingly, the information retrieved from hierarchical dataset 200 may indicate “second person with (brother or sister).”

The subject matter described herein includes means for retrieving information for the digital image from the dataset based on a hierarchical relationship between the first and second entities in the dataset. Referring to FIG. 2A, subject perspective component 216 may retrieve information from hierarchical dataset 200 using metadata associated with the digital image in image datastore 204 and the identified subject perspective. The metadata may be retrieved from within the digital image in the EXIF header or other data area within the digital image file, as specified by the digital image file format. Alternatively, the metadata may be retrieved from another record in image datastore 204 or another datastore that stores metadata associated with the digital image. From the retrieved metadata, a list of subjects may be identified. The subjects may include human subjects identified by name, location subjects identified by name or GPS coordinates, and date/time subjects identified by a normalized date/time value.

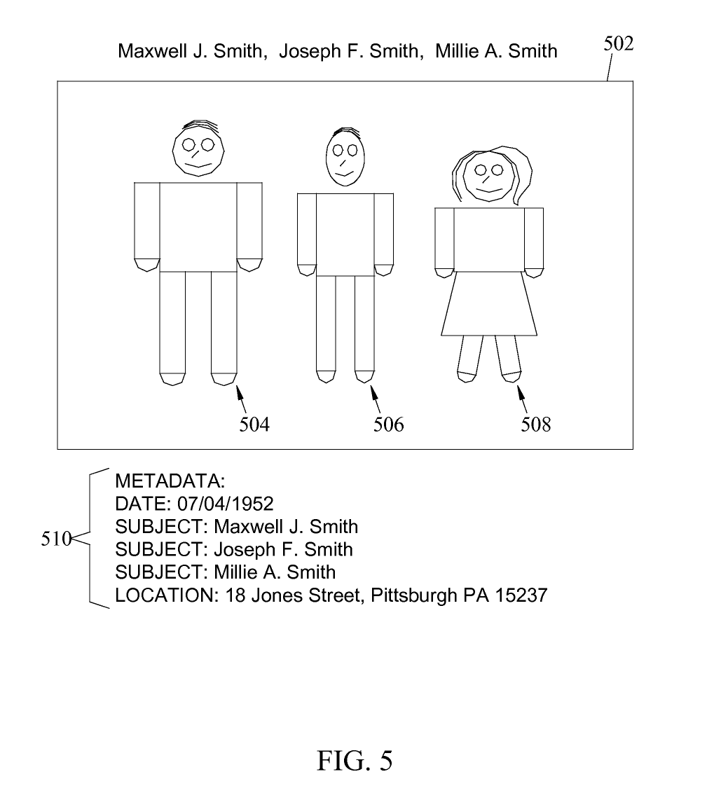

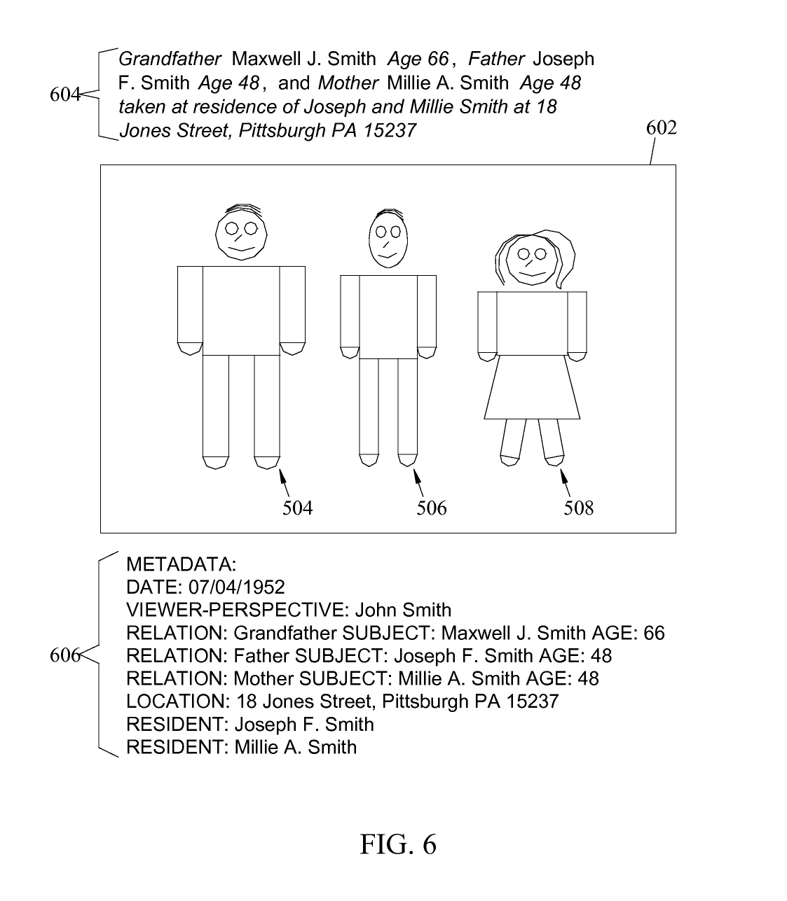

Using the associated metadata values, subject perspective component 216 may query hierarchical dataset 200 to retrieve information, such as relationship information based on a path hierarchy from a subject identified by the subject perspective to a subject identified by one of the metadata values associated with the digital image or vice versa. In one embodiment, the retrieved information is used to determine normalized values for the metadata associated with the digital image. That is, the metadata associated with a subject (e.g., the metadata used to retrieve the information from the hierarchical dataset 200) can be used to replace, append, annotate, overwrite, or otherwise modify the metadata to incorporate the retrieved information. This process will be described in more detail below with reference to FIGS. 5 and 6. Alternatively, the information can be associated with the digital image in any of a variety of other ways, such as stored in a record associated with the digital image, stored with the digital image, stored in a header of the digital image, and the like, as is discussed below.

Hierarchical dataset 200 uses a hierarchical format for the storage of subjects. For example, each generation may correspond to a different level in the hierarchy. While a genealogy database is described herein by way of example, the subject matter described herein is not limited to using a genealogy database to determine hierarchical relationships between subjects. Any dataset where hierarchical relationships between subjects can be determined is intended to be within the scope of the subject matter described herein.

Within a genealogy database, the hierarchy and the relationships of the generations of a family are represented. Other relevant data may also be stored. The other data may be data that is related to each human subject and may include gender, residence address (such as GPS coordinates), phone numbers, email addresses, significant events (such as birth date, death date, marriage date, and divorce date), and education level (such as high school degree and graduation year, college degrees with degree award year), and other desired pertinent information about the subject. In general, when the data about a subject is content rich, a richer normalization can occur.

FIG. 2B is a block diagram illustrating components of an exemplary hierarchical dataset 200 according to an embodiment of the subject matter described herein. Shown in FIG. 2B is a genealogy database 230, a table of consanguinity 232 associated with genealogy database 230, and a genealogy data processor 234. Table of consanguinity 232 includes data that maps relationships of individuals in genealogy database 230. Table of consanguinity 232 may be incorporated into genealogy database 230 or can be data that is stored accessible to genealogy database 230 and/or genealogy data processor 234. Alternatively, the information in table of consanguinity 232 may instead be included by being inherent in the structure of genealogy database 230, based, for example, on relationship records indicating a relationship between entities of genealogy database 230. In FIG. 2B, genealogy data processor 234 acts as an interface to genealogy database 230 and/or table of consanguinity 232 for processing the genealogy data and providing for the retrieval of information for the digital image by subject perspective component 216.

As described above, one type of information that can be retrieved from hierarchical dataset 200 is relationships between entities. In order to determine the relationship of a subject corresponding to the subject perspective to a subject in a digital image, the type of subject perspective is determined. If the subject perspective is a person perspective, as shown in component 302 of FIG. 3, the subject perspective may be from the perspective of a human viewer. In one exemplary embodiment, a determination must be made as to whether the human viewer is a subject corresponding to an entity in hierarchical dataset 200. For example, using the viewer's name, hierarchical dataset 200 can be searched to determine if the viewer is a subject corresponding to an entity in hierarchical dataset 200. If the viewer corresponds to an entity in hierarchical dataset 200, the relationships between the viewer and the subjects in a digital image can be determined. If the viewer is not a subject corresponding to an entity in hierarchical dataset 200, then the user has no recorded relationship to other subjects in the hierarchical dataset 200 and the subjects' metadata for the digital image would not be normalized.

Using genealogy database 230 as the exemplary hierarchical dataset 200 again by way of example, if a record of the viewer exists in genealogy database 230, the viewer may be related to one or more subjects in the digital image. For each subject represented in the metadata list of subjects for the digital image, a path search may be conducted in genealogy database 230. If a definite path can be calculated, the viewer and the subject are related, and their relationship can be determined.

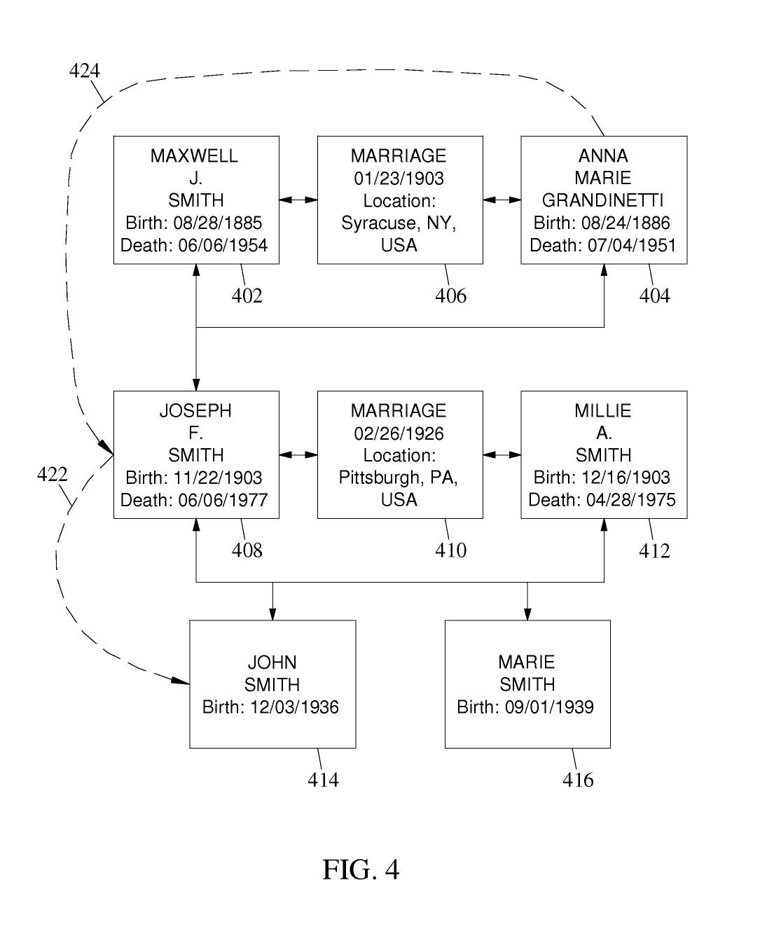

FIG. 4 is an example of relationships between entities that may be determined or extracted from a hierarchical dataset 200, which is structured by way of example as a genealogy database. Referring to FIG. 4, each box 402, 404, 406, 408, 410, 412, 414, and 416 represents an entity in genealogy database 230. In FIG. 4, dashed lines 422 and 424 represent a relationship from “Anna Marie Grandinetti” 404 to “John Smith” 414. Using table of consanguinity 232, the relationship between these two subjects can be determined by genealogy data processor 234. If Anna Marie Grandinetti is the viewer, then John Smith is determined to be her grandson and the information retrieved can be used to normalize a metadata value for “John Smith” with a caption to “Grandson John Smith.” As a further example, if the viewer and the subject are swapped, the relationship path information retrieved can be used to normalize “Anna Marie Grandinetti” to “Grandma Anna Marie Grandinetti.”

Using this technique, the relationship between the viewer or any subject in the digital image to any other subject in the digital image can be resolved to give the associated image information or metadata that has been personalized to the viewer or to any of the subjects in the digital image.

If the digital image includes date information that identifies the date the digital image was photographed or otherwise created, then the ages of the identified subjects can be automatically determined and included as normalized information for the digital image. FIG. 5 illustrates three human subjects related as depicted in the genealogical hierarchy illustrated in FIG. 4. In FIG. 5, digital image 502 includes a metadata 510 and subjects 504, 506, and 508, of which subject 504 is identified as “Maxwell J. Smith.” Maxwell's record in the hierarchy is shown as component 402 of FIG. 4. This record includes Maxwell's birth date of Aug. 28, 1885. The digital image 502 depicted in FIG. 5 is created from a photograph that was taken on Jul. 4, 1952. Performing a date calculation, Maxwell is determined to be 66 years, 10 months, and 6 days old. Using this information, the ages of each subject illustrated in FIG. 5 can be calculated. Digital image 602 shown in FIG. 6 is also based on the same photograph that includes subjects 504, 506, and 508, but additional information is displayed. The captions 604 and metadata 606 illustrated in FIG. 6 include additional information that is calculated and/or retrieved.

If the subject perspective is time/date or event, then the metadata can be normalized based on the supplied time/date/event entered into the subject perspective dialog. This is useful for determining ages of subjects, including non-human subjects. For example if a digital image is photographed at a residence, and genealogy information includes information about the land acquisition, then a date can be calculated for the age of the residence, and this information included in the normalized metadata. A typical usage of the date/time perspective is from the perspective of the date/time of a digital image as shown above.

If the subject perspective is time/date/event, the metadata of the photo can be compared against a date, revealing new information not previously associated with the digital image. For example, the date from the photo can be searched and matched to an event date in the hierarchical dataset 200. If a date match is found to an event, then the event location and the photo location represented in the photo metadata can be compared. If both comparisons match then the photo was taken at the location, on that event's time/date. The hierarchical dataset 200 can be further queried for attendees to the event, and the list of attendees not shown in the digital image could be added to the metadata for future use, or inclusion in the caption in way that describes them in the context of the photograph, e.g., “The photo shows Joseph F. Smith and Millie Smith on their Wedding Day Feb. 26, 1926. Not shown in the photo but present at the wedding is Grandfather Maxwell J. Smith.”

If the subject perspective is location, then the metadata can be normalized based on the supplied location entered into the subject perspective dialog. Locations can be entered by name, GPS coordinates, or other suitable location identifier. Map information available at Google® or other web sites can be used to convert GPS coordinates to a location name.

Using the location metadata or subject perspective, hierarchical dataset 200 can be searched for information related to the location. Information that can be extracted from hierarchical dataset 200 and associated with the digital image includes ownership information, including date ranges of ownership and information about subjects residing at the location. Using the location and the date of creation of the digital image, the residents of the location, if any, can be determined, and the information can be added to the normalized metadata. The information in FIG. 6 includes the location where the photograph was taken. A search of the hierarchical dataset 200 determines that this location was the family residence of Joseph Smith and Millie Smith at the time of the photograph. The metadata 606 and captions 604 in FIG. 6 includes the residence information and other normalizing information in italics.

Returning to FIG. 1, in block 108, the retrieved information is associated with the digital image. For example, the retrieved information from hierarchical dataset 200 can be stored in a record associated with the digital image, stored with the digital image, stored in a header of the digital image, displayed as a caption with the digital image, displayed graphically in the digital image, associated with the digital image as metadata, and the like. An associations datastore 208, shown in FIG. 2A, can be employed for storing the associated information in connection with any of these alternatives. Associations datastore 208 may be separate from and accessible to or incorporated into image information component 218. The subject matter described herein includes means for associating the retrieved information with the digital image. For example, in FIG. 2A, image information component 218 associates the retrieved information with the digital image. In one implementation, image information component 218 receives a list of metadata values that have been normalized to the subject perspective. Image information component 218 then retrieves the digital image associated with the normalized metadata from the image datastore 204. Image information component 218 then associates the retrieved information with the digital image by associating metadata with the digital image.

In one embodiment, image information component 218 merges the retrieved information with the digital image to form a single larger displayable digital image that includes both the original digital image and a rendering of the retrieved information, e.g., as normalized metadata. In this approach only the graphical elements of the source digital image and a rendering of the metadata are combined into a single composite displayable digital image. This composite digital image can then sent to an image renderer (not shown) to be displayed on an image display (not shown). For example, the digital image may be displayed computer's display monitor as either full screen, in a window, or with other digital images in a photo album arrangement. In another embodiment, the source digital image and the retrieved information, which may be normalized metadata, are sent by image information component 218 to an image renderer as separate data objects for display to be combined and displayed in a desired format for presentation on an image display.

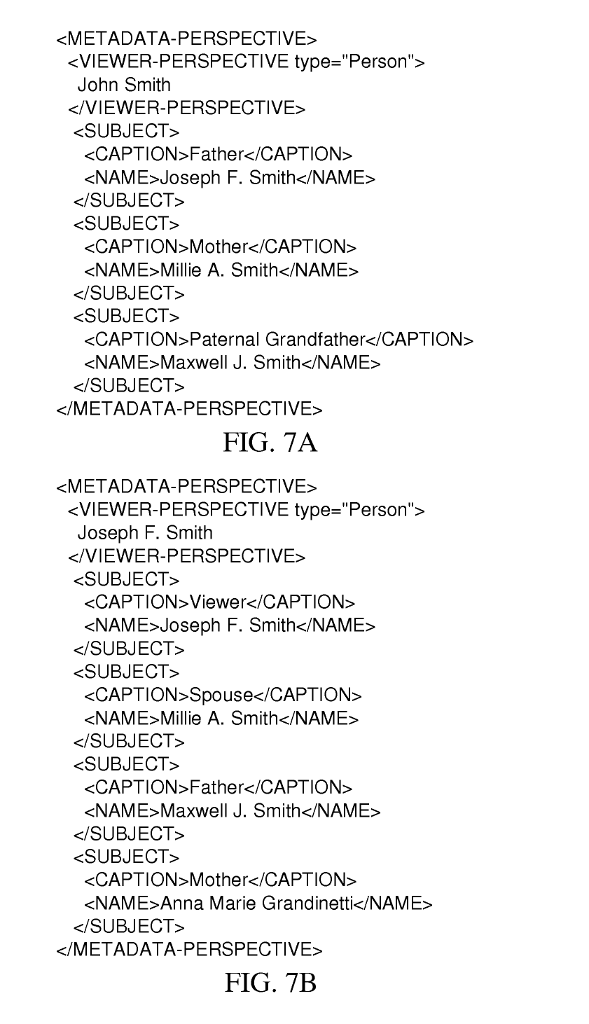

In still another embodiment, image information component 218 adds, based on the retrieved information, the information as normalized data to the metadata area of the digital image with the subject perspective identified as part of the data. In order to group the normalized data in a structured way, an XML document can be used to group the data. FIGS. 7A and 7B are illustrative examples of an XML document containing normalized metadata. The use of XML is not a requirement for this embodiment, but is useful because multiple subject perspectives can be associated with the digital image. Also if a particular subject perspective has already been associated with a digital image, the subject perspective can be retrieved from the digital image, rather than re-creating the subject perspective using subject perspective component 216, and the hierarchical dataset 200.

One instance in which it may be desirable to associate information retrieved for multiple different subject perspectives with a digital image is when the digital image will be communicated to different viewers, for example, by email. The digital image may be pre-loaded with metadata retrieved for each viewer perspective. The digital image may then be communicated to each viewer, and the metadata that is presented to each viewer may be automatically customized to that viewer's perspective.

In yet another embodiment, a digital image can be retrieved via an image API, where an image reference and a subject perspective can be passed as parameters. The image API 208 calls image information component 218 to retrieve the digital image with the normalized metadata. The digital image and the normalized metadata are returned to the caller of the image API.

In one implementation, some or all of the components in FIG. 2A can be realized as a computer based GUI application for presenting digital images from an identified subject perspective. In an alternate implementation, some or all of the components in FIG. 2A can be realized as a web application offered by a remote web server or as a web service hosted by a remote server. In a web server embodiment, the interfaces may be the same or similar to a client resident application. The operative functions of the application may be hosted on a web server and the GUI elements may be implemented as web pages that are displayed by remote client's web browser.

In a web services implementation, the service may not contain GUI elements but may include a complete API that supports the accepting of a digital image with associated metadata and that returns the digital image embedded with a caption that has been assembled from the identified subject perspective.

Although the examples described above relate primarily to digital images, the subject matter described herein is not limited to obtaining additional information for digital images. The subject matter described herein may be applied to video objects. In such an implementation, captions presented may dynamically change as subjects change in the video, based on available subject metadata associated with the media. In such an embodiment, metadata may be sampled from the video on a continual basis. As metadata identifying a subject comes into the scope in a range of the timeline of the video, the metadata may be normalized as described above for a digital image and the normalized metadata may either be added to the video in the form of a caption or written into the associated metadata for the digital image as described above based on the needs of the application or user preferences.

The subject matter described herein may also be applied to virtual reality environments where the captions are presented dynamically and change as related subjects come into and are visible in the view of the user owning the subject perspective. In a virtual reality embodiment, the API mechanism described above may be utilized. As a user first comes into the proximity of a second approaching user who may be related, an image API may be called using the person perspective with a first user identified as the subject perspective and the second user identified as the subject. If a normalized set of metadata is returned from the API, the metadata is used to identify the second user to the first user in a way that is personal to the first user.

The video and virtual reality environments described above can also be generalized to any application where the digital image content changes with time. In applications where the content of a digital image changes with time, the process described herein can be repeated for retrieving information with the digital image and automatically updating the information that is associated with the digital image based on the changing content of the digital image.

In yet another alternate embodiment, the subject matter described herein may be used to associate information with personal digital images sent via email. In such an embodiment, a user can author an email that includes one or more digital images that contain identifiable subjects. When the user sends the email to an email application, an image API calls a utility that resolves the email recipient to a subject name. Using this name, the image API is called with a person perspective with the subject perspective set to the email recipient. The email application may then retrieve from the image API digital images that have been normalized to the subject perspective of the email recipient. The system can handle multiple digital images in an email that is delivered to multiple recipients and resolve a different subject perspective for each recipient.

The following examples illustrate the functionality of the disclosed subject matter. In one example, a digital image may depict the Kennedy Family Compound. The photo may have associated metadata of “Kennedy Family Compound” and GPS coordinates for the Kennedy Family Compound. If the subject perspective identified for the digital image is a location perspective, additional address information and owner information may be looked up in a genealogy database. In this example, the following information may be retrieved and associated with the digital image:

100 Front Street
Hyannis Port, MA 02647
Owner: Edward Kennedy 1995-Present
Owner: Rose Kennedy 1944-1955

In another example, a digital image may depict John Kennedy and John Kennedy, Jr. The metadata associated with the photo may be John Kennedy with son at Kennedy Family Compound. This metadata and a perspective may be used to access a hierarchical dataset to obtain the following enhanced metadata for the digital image:

John Kennedy with Son, John Kennedy, Jr.
at Kennedy Family Compound
100 Front Street
Hyannis Port, MA

In yet another example, a digital image may depict John Kennedy, Joseph Kennedy's grandchildren, John Kennedy, Jr., and Maria Shriver at the Kennedy Family Compound. The original metadata associated with the photo may be “John Kennedy with Kennedy grandchildren and Son, John Kennedy, Jr., and niece Maria Shriver at Kennedy Family Compound.” The enhanced metadata that is retrieved from a genealogy database from the perspective of John F. Kennedy may be as follows.

John Kennedy
with Joseph Kennedy's Grandchildren
and Son John Kennedy, Jr.
and Niece Maria Shriver
at Kennedy Family Compound
100 Front Street
Hyannis Port, MA
Owner: Rose Kennedy
Perspective: John F. Kennedy

In the preceding example, if the perspective is changed to John Kennedy, Jr., the retrieved metadata may be as follows:

John F. Kennedy, Jr.
With father John F. Kennedy
Cousin: Maria Shriver
Other Cousins
Kennedy Family Compound
100 Front Street
Hyannis Port, MA
Owner: Grandmother Rose Kennedy
Perspective: John F. Kennedy, Jr.

In yet another example, the perspective for the digital image may be a location perspective. If the perspective is a location perspective, the metadata that is retrieved and associated with the digital image may be as follows:

Kennedy Family Compound
Visitors John F. Kennedy
John F. Kennedy, Jr.
Maria Shriver
Other Kennedy Relatives
100 Front Street
Hyannis Port, MA
Owner: Rose Kennedy
Future Owner: Edward Kennedy 1995
Perspective: Kennedy Family Compound

In addition to the examples above, more complex perspectives can be shown. For example, two people in a digital image may be selected to get their relationship or to retrieve all relationships and enhance metadata. The selection can be performed on the digital image or outside the digital image by selecting metadata tags, such as names. Using the digital image and related data, if John F. Kennedy, Jr. and Maria Shriver were selected, the retrieved relationship would be listed as “cousins.”

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

1. A method for associating information with a digital image, the method comprising:
receiving a digital image having associated metadata that corresponds to a first entity in a dataset that includes hierarchical relationships between entities;
identifying a subject perspective for the digital image for a subject corresponding to a second entity in the dataset;
retrieving information for the digital image from the dataset based on a hierarchical relationship between the first and second entities in the dataset; and
associating the retrieved information with the digital image.

2. The method of claim 1 wherein identifying a subject perspective includes identifying the subject perspective based on one of a viewer of the digital image and metadata concerning a subject depicted in the digital image.

3. The method of claim 1 wherein identifying a subject perspective includes identifying the subject perspective based on metadata concerning a geographic location in the digital image.

4. The method of claim 1 wherein the dataset comprises a genealogy database.

5. The method of claim 1 wherein the first and second entities are on different hierarchical levels in the dataset.

6. The method of claim 1 wherein associating the retrieved information with the digital image includes determining a relationship between a subject depicted in the digital image and the subject corresponding to the second entity in the dataset.

7. The method of claim 1 wherein associating the retrieved information with the digital image includes automatically determining an age of a subject depicted in the digital image based on the retrieved information and the metadata associated with the digital image.

8. The method of claim 1 wherein retrieving information for the digital image includes at least one of: retrieving event information based on subject and date metadata associated with the digital image and retrieving location information for the digital image based on location metadata associated with the digital image.

9. The method of claim 1 wherein associating the retrieved information with the digital image includes displaying the retrieved information with the digital image.

10. The method of claim 1 wherein retrieving information for the digital image includes retrieving information for a plurality of subject perspectives and wherein associating the retrieved information with the digital image includes associating the information retrieved for the plurality of subject perspectives with the digital image.

11. The method of claim 10 comprising communicating the digital image with the retrieved information to a viewer, selecting one of the plurality of subject perspectives based on the viewer and presenting the retrieved information associated with the selected subject perspective to the viewer.

12. The method of claim 1 wherein the digital image includes content that changes with time and wherein the method further comprises continually extracting information from the dataset as the digital image content changes and updating the information that is associated with the digital image.

13. A system for associating information with a digital image, the system comprising:
an image data selector component for receiving a digital image having associated metadata that corresponds to a first entity in a dataset that includes hierarchical relationships between entities;
a perspective identifier component for identifying a subject perspective for the digital image for a subject corresponding to a second entity in the dataset;
a subject perspective component for retrieving information for the digital image from the dataset based on a hierarchical relationship between the first and second entities in the dataset; and
an image information component for associating the retrieved information with the digital image.

14. The system of claim 13 wherein the perspective identifier component is adapted to identify the subject perspective based on one of a viewer of the digital image, metadata concerning a subject depicted in the digital image, and metadata concerning a geographic location depicted in the digital image.

15. The system of claim 13 wherein the subject perspective component is adapted to access a genealogy database to obtain the additional information.

16. The system of claim 13 wherein the first and second entities are on different hierarchical levels in the dataset.

17. The system of claim 13 wherein the information comprises a relationship between a subject depicted in the digital image and the subject corresponding to the second entity in the dataset.

18. The system of claim 13 wherein the subject perspective component is adapted to automatically calculate an age of a subject depicted in the digital image based on the retrieved information and the metadata associated with the digital image.

19. The system of claim 13 wherein the subject perspective component is adapted to retrieve event information for the digital image based on subject and date metadata associated with the digital image.

20. The system of claim 13 wherein the subject perspective component is adapted to retrieve location information for the digital image from the dataset based on location metadata associated with the digital image.

21. The system of claim 13 wherein:
the digital image includes content that changes with time;
the subject perspective component is adapted to extract information from a dataset as the digital image content changes; and
the image information component is adapted to update the information that is associated with the digital image as the digital image content changes.

22. The system of claim 13 wherein the subject perspective component is adapted to retrieve information for a plurality of subject perspectives and wherein the image information component is adapted to associate the information retrieved for the plurality of different subject perspectives with the digital image.

23. The system of claim 22 wherein the image information component is adapted to communicate with the image to a viewer to select one of the plurality of subject perspectives based on the viewer, and to present the retrieved information associated with the selected subject perspective to the viewer.

24. A system for associating selectively associating information with a digital image, the system comprising:
means for receiving a digital image having associated metadata that corresponds to a first entity in a dataset that includes hierarchical relationships between entities;
means for identifying a subject perspective for the digital image for a subject corresponding to a second entity in the dataset;
means for retrieving information for the digital image from the dataset based on a hierarchical relationship between the first and second entities in the dataset; and
means for associating the retrieved information with the digital image.

25. A computer readable medium embodying a computer program, executable by a machine, for associating information with a digital image, the computer program comprising executable instructions for:
receiving a digital image having associated metadata that corresponds to a first entity in a dataset that includes hierarchical relationships between entities;
identifying a subject perspective for the digital image for a subject corresponding to a second entity in the dataset;
retrieving information for the digital image from the dataset based on a hierarchical relationship between the first and second entities in the dataset; and
associating the retrieved information with the digital image.
